(19) United States
(12) Patent Application Publication
(10) Pub. No.: US 2004/0155630 A1
(43) Pub. Date: Aug. 12, 2004

(54) Charging controller for electric walkers

(76) Inventor: Yi-Chung Tsai, Taichung (TW)

Correspondence Address: Kuo-Hsiung Chiu, 13F., No.23, Jiun-Ho Street,, Peitun District, Taichung, 406, TW

(21) Appl. No.: 10/361,186

(22) Filed: Feb. 10, 2003

(51) Int. Cl. H02J 7/00

(52) U.S. Cl. 320/135

(57) ABSTRACT

The present invention relates to a charging controller for electric walkers comprising a charging controller and a charging driver both of which are fitted to the basic circuit of the main processor of the electric walker. Accordingly, the charging operation of the electric walker can be easily performed through a commercially available rectifier with certain rectified voltage. After the charging controller in connection with the rectifier to detect the inflow of the external power, the external current will be immediately supplied to the battery for executing the charging operation. Thereafter, this message will be sent to a microprocessor while the charging driver disconnects the linking circuit between the microprocessor and a motor after the actuation of the charging operation.

### BACKGROUND OF THE INVENTION

1. Field of the Invention

The present invention relates to a new and improved charging controller for electric walkers, and more particularly, to an apparatus which smoothly performs the charging operation for electric walkers through a commercially available rectifier with certain rectified voltage. Therefore, the inconvenience and the troubles caused by the conventional products which must be used in combination with a special charger can be avoided.

2. Description of the Prior Art

The so-called “electric walkers” means electric scooters, bicycles, wheelchairs, etc. These products make use of rechargeable batteries to supply the driving power required by the motor.

The charging operation of the conventional charging batteries used for the above-mentioned products is performed through the basic circuit shown in FIG. 2. It contains a basic circuit 10 of a main microprocessor and a special external charging controller 20. The microprocessor 12 is mainly used to control the operation (e.g. forward, backward movement, acceleration, deceleration, etc.) of the motor 14. The battery 16 is used to provide the motor 14 with proper driving power in accordance with the command of the microprocessor 12.

However, the charging operation of the conventional circuit for the battery 16 requires the special external charging controller 20 in combination with a special connection apparatus 18. During the charging operation, the charging controller 20 sends the preset message to the microprocessor 12. Thereafter, the microprocessor automatically disconnects the linking circuit between the microprocessor and the motor 14. Now, the electric walker has no power supply for ensuring the using safety. In brief, every electric walker (not shown) requires the special external charging controller 20 for a smooth charging operation because the charging controller 20 has special prearranged effect. Therefore, it can't be replaced by the universal rectifier.

Though this kind of charging process and way is familiar to the common users, it brings the users much inconvenience. The user has to constantly take care of the remaining power of the battery of the electric walker. In order to prevent this trouble, it's better to carry the special external charging controller 20 in using the electric walker. However, it is heavy and has a large volume. Thus, it's also not an optimal solution.

### SUMMARY OF THE INVENTION

It is a primary object of the present invention to eliminate the above-mentioned drawbacks and to provide a charging controller for electric walkers which includes a charging controller and a charging driver both of which are fitted to the basic circuit of the main processor of the electric walker. Accordingly, the charging operation of the electric walker can be easily performed through a commercially available rectifier with certain rectified voltage. Therefore, the use of the electric walkers is much facilitated.

### BRIEF DESCRIPTION OF THE DRAWINGS

The accomplishment of this and other objects of the invention will become apparent from the following description and its accompanying drawings of which:

FIG. 1 is a schematic drawing of a basic circuit arrangement of a preferred embodiment of the present invention; and

FIG. 2 is a schematic drawing of a basic circuit arrangement between the charging controller and the microprocessor of a conventional electric walker.

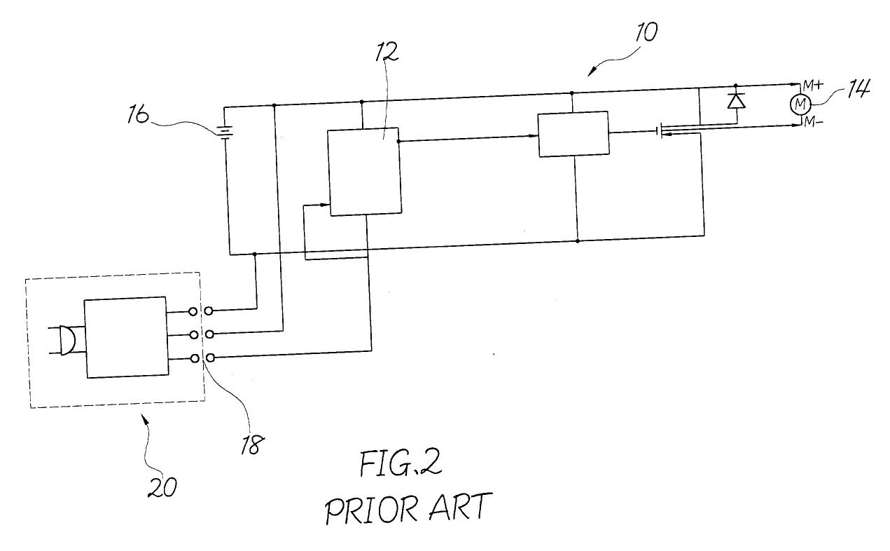

### DETAILED DESCRIPTION OF THE PREFERRED EMBODIMENT

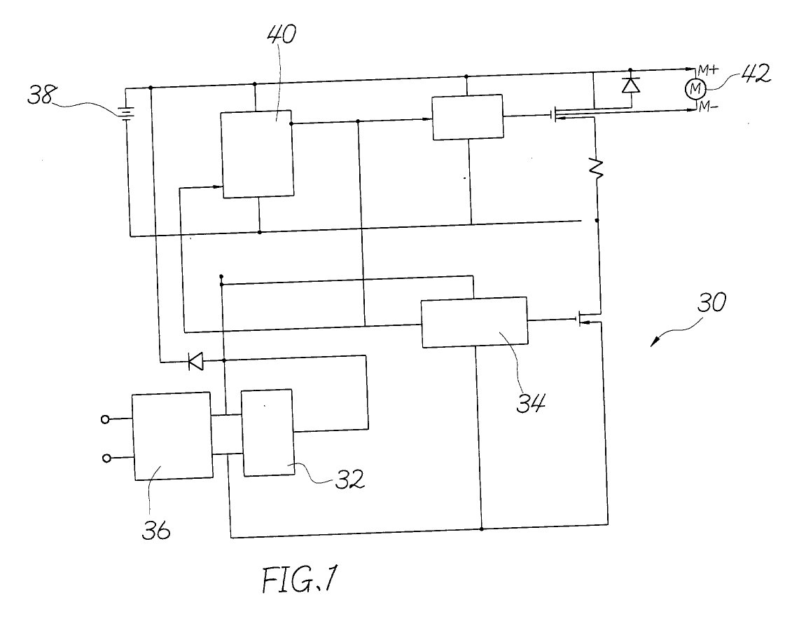

First of all, referring to FIG. 1, a preferred embodiment of the present invention is shown. A charging controller 32 and a charging driver 34 are fitted to the basic circuit 30 of the main processor of the electric walker (not shown). Accordingly, the charging operation of the electric walker can be easily performed through a commercially available rectifier 36 with certain rectified voltage.

After the charging controller 32 in connection with the rectifier 36 to detect the inflow of the external power, the external current will be immediately supplied to the battery 38 for executing the charging operation. This message will be sent to a microprocessor 40. Meanwhile, the charging driver 34 disconnects the linking circuit between the microprocessor 40 and a motor 42 after the actuation of the charging operation.

“Certain rectified voltage” means the certain voltage value of the circuit arrangement. For example, if the voltage designed for the basic circuit 30 of the main microprocessor 40 amounts to 27V, the rectifier 36 must have the same voltage value. This belongs to a basic knowledge so that no further descriptions are given hereinafter.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claim.

What is claimed is:

1. A charging controller for electric walkers comprising a charging controller and a charging driver both of which are fitted to the basic circuit of the main processor of the electric walker such that the charging operation of the electric walker can be easily performed through a commercially available rectifier with certain rectified voltage;
whereby, after the charging controller in connection with the rectifier to detect the inflow of the external power, the external current will be immediately supplied to the battery for executing the charging operation, whereupon this message will be sent to a microprocessor and the charging driver disconnects the linking circuit between the microprocessor and a motor after the actuation of the charging operation.
